(19) United States
(12) Patent Application Publication
(10) Pub. No.: US 2024/0429671 A1
(43) Pub. Date: Dec. 26, 2024

(54) MULTIPLE-STEP PROCESS FOR THE ASSEMBLY OF AND FOR THE JOINING OF AN OPTICAL RESONATOR, AND OPTICAL RESONATOR

(71) Applicant: LAYERTEC GmbH, Mellingen (DE)

(72) Inventors: Thomas BURKHARDT, Mellingen (DE); Philipp HANKE, Mellingen (DE); Max DRECHSLER, Mellingen (DE)

(21) Appl. No.: 18/750,019

(22) Filed: Jun. 21, 2024

(30) Foreign Application Priority Data
Jun. 22, 2023 (DE) 10 2023 116 485.6

(51) Int. Cl. H01S 3/08; B23K 26/06; B23K 26/21

(52) U.S. Cl. CPC H01S 3/08059; B23K 26/0643; B23K 26/21

(57) ABSTRACT

A multiple-step process for assembling and joining an optical resonator and to an optical resonator. With the process according to the invention, the mirrors of a resonator are connected to the spacer thereof after being aligned relative to one another by optical contacting via a provisional connection in which the aligned position is fixed. After checking the resonator, the provisional connection is fixed conclusively by laser welding or the provisional connection is disconnected and after aligning once again is optically contacted and checked again.

### PRIORITY CLAIM

The present application claims priority to German Patent Application No. 10 2023 116 485.6, filed on Jun. 22, 2023, which said application is incorporated by reference in its entirety herein.

### FIELD OF THE INVENTION

Optical resonators (optical cavities) are used, e.g., as laser resonators for the selection and stabilization of frequencies or wavelengths and modes in the field of measuring technology for high-resolution spectroscopy and cavity ring-down spectroscopy and in metrology. Very high finesse optical resonators are references for optical atomic clocks or an optical frequency standard, for stabilized ultranarrow-bandwidth laser systems and for optical frequency combs. The possibility of selecting and stabilizing optical frequencies is of interest in particular, the wavelength of the light in the resonator being directly related to the distance of the mirrors from one another, i.e., to the geometrical length of the spacer (resonator base body).

### BACKGROUND OF THE INVENTION

An optical resonator contains an arrangement of at least two mirrors and a spacer (resonator base body). The at least two mirrors are mounted on the spacer to produce and fix their distance and alignment relative to one another. The specific manner in which the arrangement is carried out depends on the geometry of the mirror construction. Planar resonators (both mirrors are planar), concentric and confocal resonators (both mirrors are spherical) and semi-confocal resonators (one mirror is planar and one mirror is spherical), along with others, e.g., unstable resonator geometries, are customary in resonators with two mirrors.

“Assembly” is taken to mean the putting together of components and/or groups of components to form products or assemblies of higher value-added status according to a function plan or function criteria to be met (DIN ISO 8593).

“Joining” is taken to mean the connection of two or more geometrically defined workpieces of fixed shape or the connection of workpieces with shapeless substance. The cohesion between the individual elements is provided locally and increased, respectively (DIN ISO 8593).

According to the prior art, optical resonators are produced from separate individual components, e.g., two mirrors and a spacer. The spacer is usually fabricated from the same material as the mirrors to be mounted, typically quartz glass or another glass, e.g., ULE, or a glass ceramic with a low thermal expansion coefficient. The requirements of the application determine the geometry of the spacer. Typical in this respect are, e.g., the cylindrical shape, the cylindrical shape with a notch or groove, or the shape of a prism body such as a cube without cube corners.

Aspects of longitudinal stability, i.e., a low thermal expansion, low thermal noise, low mechanical losses as well as the suitable mechanical support and fastening of the optical resonator in the overall system which are significant in terms of deformation and vibrations are of primary interest for the selected geometry and material pairing.

High finesse optical resonators, e.g., finesse in excess of 300,000, have the following requirements in particular:
mechanical longitudinal stability of the resonator influenced by the spacer, the mirrors with their mirror substrate and functional layer, and the connection of these components to one another;
low hysteresis during thermally induced change in length; this determines the selection of the possible materials for the mirror substrate and the spacer;
resistance and robustness vis-à-vis various load events such as changing environmental conditions, fluctuations in temperature and humidity, mechanical loads, particularly shocks and vibrations, for example, under transport conditions and operating conditions;
least possible mechanical deformation when acted upon by acceleration forces;
least possible aging-related longitudinal changes, particularly of the spacer, and long-term stability of the joint connection;
miniaturizability for applications with limited volume/mass budget.

The following general conditions for assembling and joining the individual parts of the optical resonator can be inferred from the above-mentioned requirements for an optical resonator:
the connection between the individual parts should be formed without additional connecting materials or intermediate layers;
the connection should be durable, permanent and stable over the long term;
the forming of the connection should not change the adjusted state of alignment of the individual parts;
the connection should be robust and stable vis-à-vis climatic alternating loads, humidity, thermal shock and various mechanical stresses such as shocks and vibrations;
the connection should protect against defects emerging close to the edge and against moisture penetrating from the edge;
the connection should have high strength, including for small joining surfaces, because this allows miniaturization of the individual parts;
the joint formation should be configurable in a spatially limited defined manner;
heating outside of the joining zone should be prevented during joining.

A common method in optics fabrication for joining individual optical parts which makes do without additional connection materials is “wringing together” or optical contacting.

Optical contacting is based on the adhesive forces between contacting optical surfaces having a high quality with respect to fit, coarseness and cleanliness. For this joining option, the joint members must have surfaces which face one another and which are either flat or have an identical surface curvature with a very high shape fidelity. They must possess optical quality, i.e., these surfaces must be machined to a high planarity and low roughness by means of optical polishing processes. The edges of the body should be faceted. All of the individual parts are to be cleaned by means of appropriate cleaning steps in such a way that there are no impurities, particularly in the form of particles and filmy contaminants.

A drawback of this joining variant is the low resistance of contact-bonded or wrung joints vis-à-vis climatic alternating loads, air humidity, thermal shock, and various mechanical stresses such as shocks and vibrations. The low resistance of the joint rules out the use of the process and of optical resonators that are produced in this manner under particularly challenging environmental conditions such as are to be found, for example, in aerospace. Moreover, the low strength of the connection does not allow the individual parts to be further reduced in size and, therefore, does not allow the miniaturization of the joined assembly, since the strength of the connection is excessively weakened when further reducing the joining surfaces. The strength of wrung joints may be reduced in particular through surface defects at the edge of the spacer which increase under load. An incursion of moisture, e.g., in high humidity or by condensation, likewise proceeds from the edge, since water can penetrate between the joining surfaces there, interfering with the connection and reducing strength. Another drawback consists in that optical contacting is impossible between joint members with different surface shapes.

The state of the art for laser welding with ultrashort pulses in the fs regime or ps regime in transparent materials is described in the article “Ultrashort-pulse laser Welding of Glass Materials for the Assembly of Optical Components [Ultrakurzpulslaserschweißen von Glaswerkstoffen für die Montage optischer Baugruppen]”, Burkhardt, T.; Schmitz, P.; Drache, F.; and Schippel in: “Lasers and Methods for Digital Manufacturing Technology [Laser und Verfahren für die digitale Fertigungstechnologie]”, 147-156, Proceedings of the 13th Jenaer Lasertagung, German Laser Welding Publications Vol. 384, ISBN 978-3-96144-208-9, 2022. This method is based on the nonlinear absorption of the radiant energy in the focus point and the heat accumulation through the interaction of a plurality of consecutive pulses at repetition rates in the high kHz or MHz range.

A substantial advantage of this joining method is the locally limited heating of the individual parts to be joined in contrast with laser welding methods with linear absorption, e.g., with a CW CO2 laser. The input of radiant energy in a spatially sharply defined manner makes it possible to produce optical assemblies with high accuracy and with a very minor influence on the individual parts and their optical functional layers. To join two parts, it is necessary to form the heat affected zone selectively over the boundary layer between these parts. With suitably selected process parameters, particularly pulse energy, pulse duration, repetition rate and feed rate when using focus optics with high numerical apertures, heat affected zones on the order of several tens of micrometers can be achieved. Further, stresses and cracks in the glass are minimized as a result of this limiting of the melt pool. Additionally, a symmetrical shape of the melt bubble is conducive to minimizing stresses. The optical contacting of the joint members prior to welding prevents the formation of free surfaces of the melt pool and accordingly suppresses the frozen-in stresses due to shrinkage during cooling. Suitably selected path guide strategies, e.g., individual melt points as opposed to melt lines, additionally enhance the mechanical strength, e.g., for quartz glass up to 85% volume strength, since crack propagation is prevented.

It may be disadvantageous for the production of an optical resonator that a joint bond produced by ultrashort-pulse laser welding is not detachable again. This results when the optical resonator does not meet the requirements imposed on it because the relative position of the mirrors with respect to one another and with respect to the spacer do not lie within tolerances. The optical resonator is unusable in this case.

### SUMMARY OF THE INVENTION

It is the object of the invention to find a process for assembling and joining an optical resonator in which the individual parts are bondingly connected to one another by means of ultrashort-pulse laser welding and in which the optical resonator reliably fulfills the requirements imposed on it.

Another object of the invention is to modify an optical resonator such that the process according to the invention is applicable for the production thereof.

The object is met for a process by a multiple-step process for assembling and joining an optical resonator comprising the following process steps: a) providing a spacer with at least two joining surfaces and at least two mirrors having in each instance a mirror substrate and a functional layer, wherein the functional layer forms a functional region and a joining region; b) cleaning the joining surfaces and the functional layers; c) mounting and aligning the at least two mirrors at the spacer such that, in each instance, the functional region adjoins a resonator cavity formed in the spacer and the joining region lies opposite one of the joining surfaces; d) provisionally joining the at least two mirrors at the spacer, wherein the mirrors are optically contacted by their joining regions to the joining surfaces so as to form an interface; e) checking the operability of the optical resonator; and f) permanently joining the joining regions to the joining surfaces by laser welding with a laser beam of an ultrashort-pulse laser when the operability has been verified or repeating process steps b-e if the operability has not been verified.

A joining pressure required for the laser welding is advantageously brought about by the adhesive forces formed with the optical contacting. Accordingly, tools by which pressure is introduced into the joining region and which could hinder the laser radiation from entering unimpeded are not employed.

The final connection has the best results when the laser beam is focused via the mirrors on or at the interface formed by the optical contacting.

In a typical annular functional region of the mirror, it is advantageous when an annular weld path enclosing the functional region 6 is formed. Contours for weld paths which are not circumferentially closed, spatially limited weld bubbles or any arrangement of individual weld bubbles in the joining region may also be suitable.

For an optical resonator with at least two mirrors and a spacer, with at least two joining surfaces, wherein the two mirrors have in each instance a mirror substrate and a functional layer and the functional layer in each instance forms a functional region which adjoins a resonator cavity formed in the spacer and forms a joining region which is bondingly connected to one of the joining surfaces along a weld path, the above-stated object is met in that the functional region of at least one of the at least two mirrors has a spherical, aspherical or free formed shape and the joining regions of all of the mirrors are planar surfaces.

In each instance, the joining regions are preferably annular and have an inner diameter which is larger than an outer diameter of the resonator cavity and open into one of the joining surfaces, respectively.

The weld path is preferably narrower than the joining region so that a heat input brought about by the laser welding does not occur directly adjoining the functional region so that the functional layer inside of the functional region is protected.

An outwardly secured, permanently tight connection is produced in that the weld path, which is narrower than the joining region, adjoins an outer surface boundary of the joining region.

### BRIEF DESCRIPTION OF THE DRAWINGS

The invention will be described more fully in the following with reference to an embodiment example. The drawings show:

FIG. 1 a sectional view of an optical resonator;

FIG. 2 an enlarged detail of the sectional view according to FIG. 1; and

FIG. 3 a side view depicting selected regions.

### DETAILED DESCRIPTION

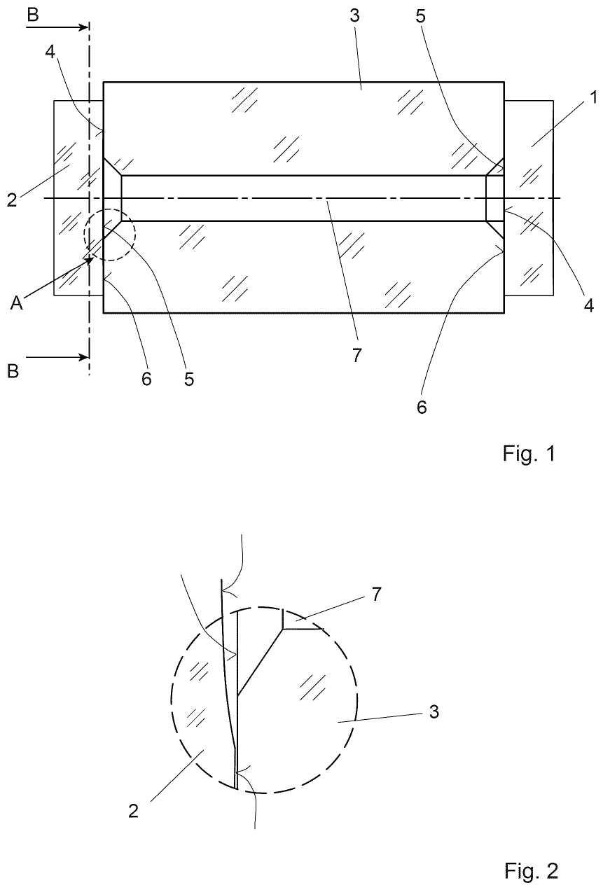

The process will be described with reference to a resonator with two mirrors 1, 2. The latter may have a planar, spherical, aspherical or free formed mirror surface. In the first embodiment example, shown in FIG. 1, the optical resonator specifically comprises a plane mirror 1 and a concave mirror 2. The process is also applicable to resonators with more than two mirrors.

The process starts with providing two mirrors 1, 2 and a spacer 3 which are to be connected to one another to form an optical resonator. The mirrors 1, 2 are formed in each instance from a mirror substrate and a functional layer which forms the mirror surface.

Regardless of the shape of the mirror surface of the mirrors 1, 2, the mirror surfaces in each instance can be divided into a functional region 5 and a joining region 6.

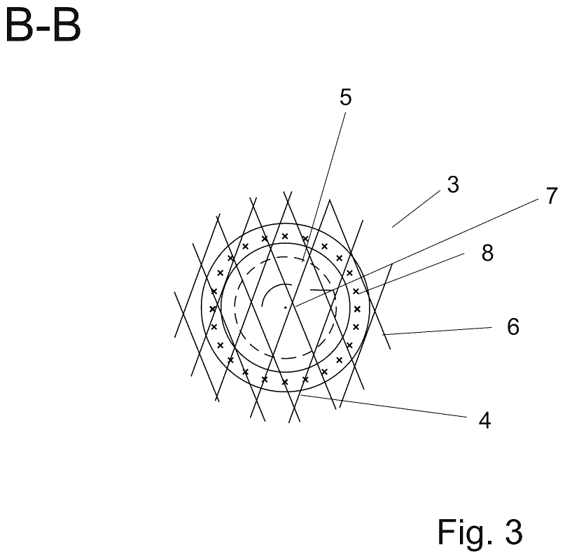

The functional region 5 is the surface region which is arranged adjoining a resonator cavity 7 formed in the spacer 3 and at which radiation is reflected and amplified. The functional region 5 is slightly larger than the diameter of the resonator cavity 7 opening into the joining surface 4. FIG. 3 shows the functional region 5 lying within the dotted line. For functional reasons, the functional region 5 can be planar, spherical, aspherical or free formed depending on whether or not the radiation is to be reflected only or also shaped. The joining region 6, shown lying outside of the dashed line in FIG. 3, is planar on each of the mirrors 1, 2 irrespective of the execution of the functional region 5. In an operable relationship of the functional regions 5 to the spacer 3, the joining regions 6 are positioned in each instance parallel to one of the joining surfaces 4.

It is key to the invention that the joining regions 6 are planar irrespective of the shape of the functional regions 5 in order to join the optical resonator provisionally by optical contacting according to the invention. In case of mirrors with a non-planar mirror surface such as a concave mirror surface which may be seen more clearly in FIG. 2, this means an increased manufacturing expenditure for the mirrors in which an annular planar joining region is produced around the spherical functional region 5. However, the increased manufacturing expenditure is offset by the advantage that a provisional connection can be produced by optical contacting.

The spacer 3 is formed in this instance in cylindrical shape and has two joining surfaces 4 which are parallel to one another.

At least the joining surfaces 4 at the spacer 3 and the joining surfaces at the mirrors 1, 2 are cleaned before assembly. Subsequently, the mirrors 1, 2 are positioned by their functional surfaces with respect to the joining surfaces 4 at the spacer 3, aligned and optically contacted. In this way, a provisional connection is produced which connects the entire joining region 6 to at least one portion of the joining surface 4 in a frictionally engaging manner in each instance and constitutes an interface which is formed by optical contacting. An alignment position of the mirrors 1, 2 relative to the spacer which has been adjusted beforehand is fixed in such a way that it is detachable again subsequently.

The optical resonator is now subjected to a functionality test, e.g., in the form of a cavity ring-down measurement, and further inspections and characterization measurements. If the requirements imposed on the optical resonator are not met and, e.g., defects or a defective alignment is determined or functional criteria, e.g., the level of finesse, are not met, this provisional connection can be detached and produced anew after a renewed cleaning.

The necessary steps for producing this provisional connection, particularly the handling, positioning and alignment of the individual parts relative to one another, monitoring processes and other auxiliary processes, are configured in such a way that the functioning of the optical resonator is achieved and maintained, particularly as represented by the achievement of a very high finesse, e.g., in excess of 300,000. For the alignment of semi-confocal resonators as suggested here by way of example, undirected joining, i.e., a passive alignment by means of stops and auxiliary devices, is sufficient. A directed joining, i.e., an active alignment, in which the functioning of the system is monitored while the assembly is actively adjusted is necessary in other resonator geometries.

The provisional connection which is produced by means of optical contacting is subsequently locally strengthened in a second step and in a separate process by means of a laser welding process. The laser radiation is beamed into the mirrors 1, 2 during the laser welding through the outer plane surfaces of the mirror substrates in each instance such that the focus settles on or near the interface formed by the optical contacting between the joining surface at the spacer 3 and the mirror 1, 2. The mirrors 1, 2 and the spacer 3 are heated in a locally defined manner in the focus by nonlinear absorption of the laser radiation such that their materials soften or melt. The mirrors 1 bondingly connect respectively with the spacer 3 in this “melt pool” during the subsequent cooling. By means of suitable steps, i.e., the relative movement of workpiece and laser focus, the melt pool can be moved in various geometries, e.g., also in the shape of closed contours (weld path), and forms the connection in the desired subregions. FIG. 3 shows an annular weld path 8. It lies within the area of the interface produced by optical contacting. Since the relative position of the mirror 1, 2 with respect to the spacer 3 is already fixed by means of the optical contacting, it is ensured that the adjusted, provisionally fixed state is maintained and is only conclusively fixed. The conclusive connection produced in this way is irreversible and insoluble and is intended to permanently join the individual parts. The alignment state, i.e., the relative spatial relationship of the mirrors with respect to one another, is not altered compared to the provisional connection by means of optical contacting.

The laser wavelength of the machining laser is selected in a range in which the mirror substrate and the spacer are extensively transparent, i.e., can be penetrated by the incident laser radiation—in the convergent beam outside of the focus area—without linear absorption. Typical wavelengths lie in the VIS and NIR range.

The laser radiation is applied in the form of pulse trains of short or ultrashort pulses, preferably in the picosecond to femtosecond regime, with repetition rates in the 10 kHz to 10 MHz range, preferably in the range of several hundreds of kHz.

The laser radiation achieves such a high radiant exposure in the focus, typically in excess of 10¹² W/cm², that the laser radiation is locally absorbed by means of nonlinear absorption processes, particularly multiphoton absorption and field ionization as well as subsequent linear absorption in the plasma that is formed, and leads to local heating and, therefore, local softening or melting of the base materials of the mirror substrate and of the spacer, respectively.

The repetition rate of the pulses is adapted to the time constant of the thermal diffusion in the material in such a way that a heat accumulation can occur.

The focus of the laser beam is located on or near the interface between the mirror substrate and the spacer in each instance such that the mirror substrate and the spacer are locally softened or melted in the region of the thermal interaction zone. These areas open into one another so that the connection is formed locally.

The resulting interaction zone of the molten areas which form the actual connection is spatially narrowly defined, e.g., configured in the form of individual weld bubbles or continuous weld paths. The connection preferably constitutes in each instance an annular weld path enclosing the functional region.

The position of the interaction zone (melt pool, weld bubble, weld path) is located on the individual parts, as intended, by means of suitable technology, e.g., CNC displacement systems or laser deflecting systems (scanner).

The feed rate is adapted with the laser parameters, in particular the pulse duration, the repetition rate and the pulse energy, and with the thermal-physical characteristics of the substrate materials such that a homogeneous, uniform and symmetrical shape of the melt pool is formed.

Due to the fact that thermal energy is introduced in a spatially narrowly defined manner, the substrate, the optical functional layers mounted thereon and the spacer are heated only to a limited extent outside of the interaction zone so as to prevent damage and to avoid alteration of the characteristics of the functional layers. Further, deformations of the mirror substrate and mechanical stresses are prevented or minimized.

The connections of the optical resonator joined in accordance with the invention exhibit all of the advantages of a connection welded by means of an ultrashort-pulse laser. At the same time, an optical resonator is formed by provisional joining by means of optical contacting with all of its parameters which can be checked before a final joining takes place. In this respect, it is not obvious to a person skilled in the art to combine optical contacting as provisional joining with laser welding as final joining. Mirrors with a spherical, aspherical or free formed mirror surface such as is usually produced without a planar edge area cannot be optically contacted. In the development of a novel process or improvement of a process, the person skilled in the art always has the aim in view that this novel process or improved process can be used in the intended manner without limitation. The person skilled in the art would not unreservedly modify a mirror that can be connected to the spacer by laser welding.

The resulting connection has a very high mechanical strength and stability and is highly robust vis-à-vis climatic alternating loads, humidity, thermal shock and various mechanical stresses, particularly shocks and vibrations. The optical cavity produced in this way accordingly permanently retains its high finesse as assembly. The very high strength allows the individual parts to be miniaturized. Because of the provisional joining by optical contacting and the adhesive forces brought to bear in this manner, no additional joining pressure is required during the laser welding.

An optical resonator according to the invention is mechanically stable and resistant to environmental influences, e.g., mechanical vibrations, mechanical shock and climatic loads.

### REFERENCE NUMERALS

1 plane mirror
2 convex mirror
3 spacer
4 joining surface
5 functional region
6 joining region
7 resonator cavity
8 weld path

1. A multiple-step process for assembling and joining an optical resonator comprising the following process steps:
a) providing a spacer with at least two joining surfaces and at least two mirrors having in each instance a mirror substrate and a functional layer, wherein the functional layer forms a functional region and a joining region;
b) cleaning the joining surfaces and the functional layers;
c) mounting and aligning the at least two mirrors at the spacer such that, in each instance, the functional region adjoins a resonator cavity formed in the spacer and the joining region lies opposite one of the joining surfaces;
d) provisionally joining the at least two mirrors at the spacer, wherein the mirrors are optically contacted by their joining region to the joining surfaces so as to form an interface;
e) checking the operability of the optical resonator; and
f) permanently joining the joining regions to the joining surfaces by laser welding with a laser beam of an ultrashort-pulse laser when the operability has been verified or repeating process steps b-e if the operability has not been verified.

2. The multiple-step process for assembling and joining an optical resonator according to claim 1, wherein a joining pressure required for the laser welding is brought about by adhesive forces formed with the optical contacting.

3. The multiple-step process for assembling and joining an optical resonator according to claim 1, wherein the laser beam is focused via the mirrors on or at the interface formed by the optical contacting.

4. The multiple-step process for assembling and joining an optical resonator according to claim 1, wherein an annular weld path enclosing the functional region is formed.

5. An optical resonator with at least two mirrors and a spacer, with at least two joining surfaces, wherein the two mirrors each have a mirror substrate and a functional layer and each of the functional layers forms a functional region which adjoins a resonator cavity formed in the spacer and forms a joining region which is bondingly connected to one of the joining surfaces along a weld path, wherein the functional region of at least one of the at least two mirrors has a spherical, aspherical or free-formed shape and the joining regions of all of the mirrors are planar surfaces.

6. The optical resonator according to claim 5, wherein, each of the joining regions are annular and have an inner diameter which is larger than an outer diameter of the resonator cavity and open into one of the joining surfaces, respectively.

7. The optical resonator according to claim 5, wherein the weld path is narrower than the joining region.

8. The optical resonator according to claim 7, wherein the weld path adjoins an outer surface boundary of the joining region.
